(19) United States
(12) Patent Application Publication
(10) Pub. No.: US 2008/0097949 A1
(43) Pub. Date: Apr. 24, 2008

(54) Apparatus and Method for Estimating User Interest Degree of a Program

(75) Inventors: Declan Patrick Kelly, Shanghai (CN); Xiaowei Shi, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,957

(22) PCT Filed: Nov. 28, 2005
(86) PCT No.: PCT/IB05/53916

§ 371 Date: May 23, 2007

(30) Foreign Application Priority Data
Nov. 30, 2004 (CN) 200410100111.6

(51) Int. Cl. G06N 7/02; G06N 5/00

(52) U.S. Cl. 706/52; 706/45

(57) ABSTRACT

The present invention provides a method for estimating a user's interest degree in a playing program, the method includes the steps of: monitoring the user's behavior on the program including at least two segments, and each of them correspond to different time weight; determining the length and the time weight of the segment played corresponding to the user's behavior; and acquiring the user's interest degree in the program according to the length and the time weight of segment played.

### FIELD OF THE INVENTION

This invention relates to an information recommendation system, in particular to a method and apparatus for estimating a user's interest degree in a program.

### BACKGROUND OF THE INVENTION

With the development of modern technology of communications, people could acquire a lot of information at any time. However, the sharp increase in the amount of information also makes people feel at loose ends, so there is an urgent need for a tool that could help people to rapidly find the contents that they are really interested in, i.e., a personalized information recommendation system.

In order to satisfy the constantly changing user's interests, the user profile in the information recommendation system has to be constantly changed. Therefore, it has become the problem to be solved at present as to how to dynamically modify the user profile in the recommendation system according to the user's interest (like degree), so as to recommend to him the contents that he is really interested in.

Currently, the behaviors of the user when watching a specific program are usually used as the basis for modifying the user's like-degree and the weight for the content features of the specific program in the user profile. The user's behaviors include the time length for the user to watch the specific program, the times for the user to watch and the times for the user to delete the program that includes the content features.

The content features refer to the actors' names (e.g., Fan Bingbing, Ge You) included in the program, the types of program (literary movie, romance movie and horror movie, etc.), the director (e.g., Zhang Yimou, Feng Xiaogang, etc.), and so on in the program. These content features could be from information sources such as the broadcast, television or the Internet, etc, among which the most representative one is that they are transmitted to the user together with the program by the digital television electronic program guide (EPG).

When modifying the user profile according to the user's behaviors in watching, the time length at which the user watches some specific program is usually obtained first and is subtracted by a pre-set threshold value, then the user's interest degree in the program is obtained on the basis of the ratio of the difference to the pre-set time length for playing the program so as to modify the user profile.

The user's interest degree could be represented by

$$\frac{( {W}_{Di} - θ )}{{R}_{Di}} * 10 ,$$

wherein W_{Di} represents the time length at which the user watches a specific program; θ is a pre-set threshold which could be pre-set by the program provider; R_{Di} represents the pre-set total time length for playing the specific program.

However, such method of obtained the interest degree is too simple to reflect the change of user's interest degree very accurately. Because many other situations exist when the user watches a specific program, for example, trying the program to see if he likes it, skimming over the program when switching the channels, constantly switching to other programs when watching the program, switching to the program when watching other programs, temporarily stopping watching the program, etc., and, under these circumstances, it is hard to very accurately obtain the user's interest degree only through determining if the user likes the program and the corresponding content features by the time length at which the user has watched the program content. All these other situations are referred to as interruption in the following text.

For example, a specific program is in itself very short, but the user found that he did not like the specific program at all only after trying a better half of the program content from the beginning, in this case, if it is determined that the user likes this program and the corresponding content features only on the basis that the user has watched a better half of the program, the real interest of the user can hardly be reflected, this is because that the program is so short that merely a try takes a better half of the program.

Moreover, if the user starts watching the program only from a better half of the program, then it will also hard to reflect the user's real interest by determining that the user does not like the program and the corresponding content features because he has only watched a smaller part of the program, this is because that it is much possible that the user found this specific program being played is very interest only after watching another program to the end, and thus he finished watching this specific program from a better half of it.

In addition, the constant interruption, such as switching to other programs or temporarily stopping watching, may be caused by the reason that the user does not like the program very much. Under such circumstance, even if the user does not like the program, a very large part of the program may still be watched accumulatively during the constant switching of channels or pauses. Then if the user's interest degree is acquired on the basis of the time length for watching which corresponds to the large part of content of the program, the user's interest can hardly be accurately reflected.

In summary, the current method of estimating a user's interest degree in a program and modifying the user profile accordingly on the basis of the time length at which the user watches a specific program and the pre-set total time length for playing the program is not so perfect and cannot very accurately reflect the real change of interest of the user.

Therefore, the present invention provides a method and apparatus for estimating the user's interest the user's interest degree in a program more accurately and thereby to dynamically update the user profile.

### OBJECT AND SUMMARY OF THE INVENTION

One of the objects of the present invention is to provide a method and apparatus for estimating the user's interest degree in a program so as to more accurately acquire the user's interest degree, and a method and apparatus for updating the user profile by means of sad interest degree.

The method for estimating the user's interest degree in a playing program according to the present invention comprises the following steps: monitoring the user's behaviors on the program including at least two segments corresponding to different time weight respectively; determining the length and the time weight of the segment played corresponding to the user's behavior; and acquiring the user's interest degree in the program according to the length and the time weight of segment played.

One embodiment of the present invention is that the user's behavior includes the times of interruption in playing the program by the user. When acquiring the user's interest degree in the program, the influence of the times of interruption will be taken into account.

In the method of estimating the user's interest degree in a program of the present invention, different segments of a program could correspond to different time weights. The length of the segment played that corresponds to the user's behavior is adjusted according to the different time weights to which the at least two segments correspond respectively, therefore, such a case as in the prior art is avoided that as long as the lengths of the segments played are the same, the user's like-degree for each content feature of the program will be considered as the same despite of whichever played segment of the program is watched by the user; thereby the inaccuracy in estimating the user's interest degree is reduced.

The method of updating user profile according to the present invention comprises the following steps: monitoring a user's behavior on a playing program including at least two segments which correspond to different time weights respectively; determining the length and the time weight of the segment played corresponding to the behavior; acquiring the user's interest degree in the program according to the length and the time weight of segment played; and modifying the user profile according to the interest degree.

The apparatus for estimating the user's interest degree in a playing program according to the present invention comprises an interactive means, a determining means and an acquiring means. The interactive means is used for monitoring the user's behavior on the program including at least two segments which correspond to different time weight respectively; the determining means is used for determining the length and the time weight of the segment played corresponding to the behavior; the acquiring means is used for acquiring the user's interest degree in the program according to the length and the time weight of segment played.

The apparatus for updating the user profile according to the present invention comprises an interactive means, a determining means, an acquiring means, and a modifying means. The interactive means is used for monitoring the user's behavior on the program, the program including at least two segments which correspond to different time weight respectively; the determining means is used for determining the length and the time weight of the segment played corresponding to the behavior; the acquiring means is used for acquiring the user's interest degree in the program according to the length and the time weight of segment played; and the modifying means is used for modifying the user profile according to the interest degree.

Other objects and attainments together with a fuller understanding of the invention will become apparent and appreciated by referring to the following description and claims taken in conjunction with the accompanying drawings.

### BRIEF DESCRIPTION OF DRAWINGS

The present invention is explained in detail by means of embodiments with reference to the drawings, wherein

FIG. 1 is the schematic drawing of the structure of the information recommendation system according to one embodiment of the present invention;

FIG. 2 is a curve diagram showing the variation of the time weight with the time for playing the program according to one embodiment of the present invention;

FIG. 3 is another curve diagram showing the variation of the time weight with the time for playing the program according to one embodiment of the present invention;

FIG. 4 is a flow chart of estimating the user's interest degree in a playing program and modifying the user profile according to one embodiment of the present invention;

FIG. 5 is a flow chart of acquiring the time weight by means of fuzzy logic reference rule according to one embodiment of the present invention;

FIG. 6 is the graph of the fuzzy set of the input variable e1 of FIG. 5;

FIG. 7 is the graph of the fuzzy set of the input variable e2 of FIG. 5;

FIG. 8 is the graph of the fuzzy set of the output variable αᵢ of FIG. 5;

Throughout the figures, the same reference numerals denote the similar or same features or functions.

### DETAILED DESCRIPTION OF THE INVENTION

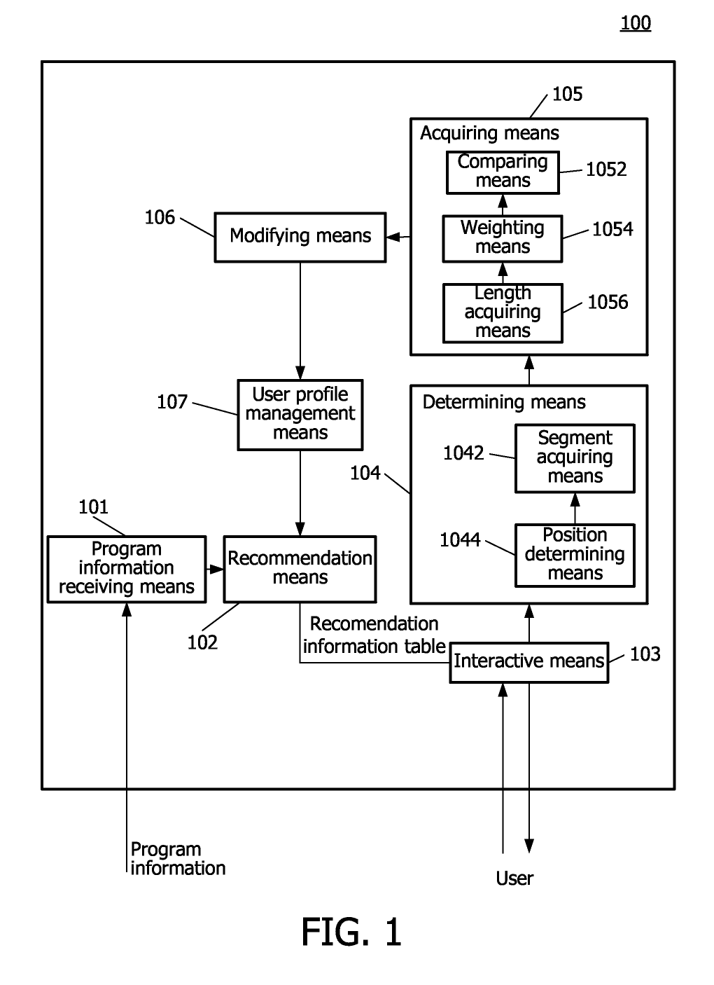

FIG. 1 is the schematic drawing of the structure of the information recommendation system according to one embodiment of the present invention.

System 100 includes an interactive means 103, a determining means 104, an acquiring means 105 and a modifying means 106.

The interactive means 103 is used for monitoring the user's behavior on a specific program, the program including at least two segments which correspond to different time weight respectively.

The user's behavior includes the position at which the playing of the program is interrupted each time, the times of interruptions, the length of the segment played from the corresponding starting position for watching to the interruption position, etc. The starting position for watching could be the zero minute position of a program, and the interruption position could be the termination position of the playing of the program.

Time weight refers to the coefficient for adjusting the length of a played segment watched by the user and for reducing, increasing or maintaining the length of the segment played. The time weight could be determined on the basis of the position of playing the segment in the program and the times of interruptions during the user's watching of the program, or it could be determined by the time weight curve pre-set by the user or by the time weight curve pre-set by the program provider and sent to the user.

The program includes at least two segments which correspond to different time weight respectively. In other words, the time weights of at least two segments in the program are different. The segment played is the segment that has been watched by the user. For example, if the total time length for playing a program is pre-set to be 120 minutes, i.e., the total length of the program is 120 minutes, then the time weight of the former 60 minutes is 0.5 and that of the latter 60 minutes is 1.5.

The determining means 104 is used for determining the length of the segment played and the time weight corresponding to the user's behavior. The determining means 104 comprises a position determining means 1042 and a segment acquiring means 1044.

The position determining means 1042 is used for determining the position of the corresponding segment played on the basis of a interruption position when the user watches the previously mentioned specific program.

The segment acquiring means 1044 is used for acquiring the length of the segment played and the time weight on the basis of the position of the segment played.

The above-mentioned length of segment played usually refers to the time length at which the user watches the previously mentioned specific program, and it could be determined by the user's behavior.

The time weight is the time weight of the segment played, i.e., a specific time weight with respect to the segment played, which could be acquired from the position of the segment played and the corresponding time weight curve pre-set by the user or by the program provider; or it could be acquired by fuzzy logic reference rule, the process of fuzzy logic reference rule could use the interruption times and position in the user's behavior as the input variables and use the corresponding time weight of the segment played as the output variable, and thus to acquire the time weight of the segment played.

The acquiring means comprises a length acquiring means 1056, a weighting means 1054 and a comparing means 1052.

While not considering the times of interruption, the acquiring means 105 could be used for acquiring the user's interest degree in the specific program on the basis of the length of the segment played and the time weight.

The length acquiring means 1056 is used for acquiring the pre-set total time length for playing the specific program, i.e., the total length of the program; the weighing means 1054 is used for processing the length of the segment played and the time weight so as to obtain a weighted length of the segment played, and usually, the weighted length of segment played is obtained by multiplying the length of the segment played and the corresponding time weight; the comparing means 1052 is used for comparing the pre-set total time length of playing the program and the weighted length of the segment played so as to obtain the user's interest degree in the program.

The interest degree could be represented by

$$\frac{( {W}_{Di} - θ )}{{R}_{Di}} * 10 ,$$

wherein i indicates the content features included in the program, W_{Di} equals to the weighted length of the segment played obtained by multiplying the length and the time weight of the segment played, R_{Di} indicates the pre-set total time length for playing the program, θ is a pre-set threshold which could be pre-set by the user or by the program provider and then sent to the user.

Wherein the magnitude of value of θ is usually determined by the pre-set total time length for playing the program, and it generally does not exceed half of the pre-set time length for playing the program. For instance, if a pre-set total time length for playing a program is 120 minutes, then θ could be set as 20 minutes.

While considering the times of interruption, the acquiring means 105 could also acquire the user's interest degree in the program according to the length of the segment played as well as the time weight and the times of playing interruptions. That is, the above-mentioned weighting means 1054 could also be used for subtracting the influence brought by the times of interruption from the weighted length of the segment played.

The modifying means 106 is used for modifying the user profile according to the interest degree.

The system 100 further comprises a program information receiving means 101, a recommendation means 102 and a user profile management means 107.

The program information receiving means 101 is used for receiving program information and the digital television electronic program guide (EPG) corresponding to the program, etc.

The recommendation means 102 is used for screen out the programs that the user might like so as to recommend the information of the programs to the user in the form of a recommendation information list.

The user profile management means 107 is used for managing the user profile. The user profile usually includes the like-degree of the user to at least one content feature and the weight.

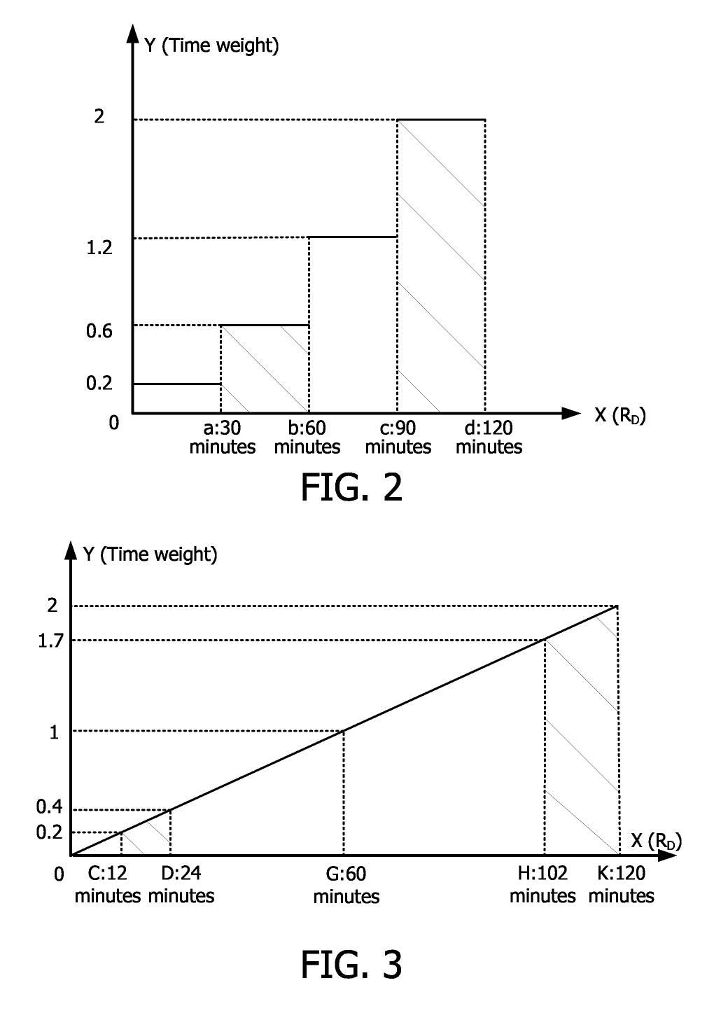

The time weight pre-set by the user or by the program provider could be a curve of the time weight varying with the change of the time for playing the program, and it is explained in the following by two different embodiments of FIGS. 2 and 3.

FIG. 2 is a curve diagram showing the variation of the time weight with the time for playing the program according to one embodiment of the present invention. The figure shows the variation of the time weight of movie A with the time of playing, wherein the movie A includes actor F. In the figure, the curve of the variation of the time weight with the time of playing is a discrete curve.

The X axis (R_{D}) in the coordinates in the figure indicates the time for playing movie A, and the pre-set total time length for playing movie A is 120 minutes, i.e., the total time length is 120 minutes; and the Y axis indicates the time weight.

The figure indicates that the movie A is divided into four segments, and each of them have a different time weight. The time weight of segment 0a is 0.2, and the length of the segment is 30−0=30 minutes; the time weight of segment ab is 0.6, and the length of the segment is 60−30=30 minutes; the time weight of segment bc is 1.2, and the length of the segment is 90−60=30 minutes; the time weight of segment cd is 2, and the length of the segment is 120−90=30 minutes.

By multiplying the time weight of each segment and the corresponding length of segment, the corresponding weighted time length is obtained. For example, the weighted time length of segment 0a is 0.2*30=6 minutes; the weighted time length of segment ab is 0.6*30=18 minutes; the weighted time length of segment bc is 1.2*30=36 minutes; the weighted time length of segment cd is 2*30=60 minutes.

The sum of the weighted time lengths of the above-mentioned segments is 6+18+36+60=120 minutes, which equals to the pre-set total time for playing movie A. That is to say, generally, the sum of the weighted time length of all the segments of a program equals to the pre-set total time length for playing the program.

If the user only watches segments ab and cd in movie A, i.e., the user only watches segment ab played and segment cd played, then the weighted length of the segments played in movie A is 18+60=78 minutes.

a and c are two starting positions for the user to watch two segments played in movie A, and they lie in the positions of 30 minutes and 90 minutes, respectively; b and d are the interruption positions of the two segments played which lie in the positions of 60 minutes and 120 minutes, respectively, wherein b is the position of the first interruption and d is the position of the second interruption.

It can be seen that the length of the segment played and the corresponding time weight could be determined by the corresponding starting position for watching and the interruption position, and the 0 minute position of the program could also be the starting position for watching and the 120 minutes position which is the terminal of the program could be the interruption position.

Of course, the above division of segments is only an example, while actually the segment watched by the user, i.e., the segment played, could start at any time point of the program and end at another later time point in the program. For instance, the user starts watching movie A from the middle point of segment ab, and interrupts it at the middle point of segment cd, then the segment from the middle point of segment ab to the middle point of segment cd is a segment played that is watched by the user in movie A.

After obtaining the weighted length of the segment played, the user's interest degree in movie A could be acquired through the sum of the weighted lengths of the segments played.

FIG. 3 is a curve diagram showing the variation of the time weight with the time for playing the program according to another embodiment of the present invention. The figure shows the variation of the time weight of movie B with the time of playing, wherein the movie B includes actor T. In the figure, the curve of the variation of the time weight with the time of playing is a continuous curve.

The X axis (R_{D}) in the coordinates in the figure indicates the time for playing movie B, and the pre-set total time length for playing movie B is 120 minutes, i.e., the total time length is 120 minutes; and the Y axis indicates the time weight. The figure shows that with the progress of the time for playing the program, the corresponding time weight is constantly changing, and the time weight and the time for playing is of the proportional relationship of ratio, i.e., Y=X/60.

The figure indicates that the movie B is divided into five segments: segment 0C, segment CD, segment DG, segment GH and segment HK, each of them has a different time weight, wherein,

regarding segment 0C:
the length of the segment is 12 minutes;
the weighted length of segment is 12*0.2*0.5=1.2 minutes; and
the time weight is 1.2/12=0.1;

regarding segment CD:
the length of the segment is 24−12=12 minutes;
the weighted length of segment is (0.2+0.4)*12/2=3.6 minutes; and
the time weight is 3.6/12=0.3;

regarding segment DG:
the length of the segment is 60−24=36 minutes;
the weighted length of segment is (0.4+1)*36/2=25.2 minutes; and
the time weight is 25.2/36=0.7;

regarding segment GH:
the length of the segment is 102−60=42 minutes;
the weighted length of segment is (1+1.7)*42/2=56.7 minutes; and
the time weight is 56.7/42=1.35;

regarding segment HK:
the length of the segment is 120−102=18 minutes;
the weighted length of segment is (1.7+2)*18/2=33.3 minutes; and
the time weight is 33.3/18=1.85.

Of course, the above division of segments is only an example, while actually the segment watched by the user, i.e., the segment played, could start at any time point of the program and end at another later time point in the program. For instance, the user starts watching movie B from the middle point of segment CD, and interrupts when watching it up to the middle point of segment GH, then the segment from the middle point of segment CD to the middle point of segment GH is a segment played that is watched by the user in movie B.

It can be seen from the above that the area formed by each segment and its corresponding curve is the weighted segment length of the segment, then if the area is divided by the segment length, the corresponding time weight could be obtained, which is the average time weight of the segment.

The sum of the weighted segment lengths of the above-mentioned segments is 1.2+3.6+25.2+56.7+33.3=120 minutes, which equals to the pre-set total time length for playing movie B, i.e., the total length of movie B. In other words, generally, the sum of the weighted time lengths of all the segments of a program equals to the pre-set time length for playing the program.

If the user only watches segments CD and HK of movie B, i.e., the user only watches the segment CD for playing and segment HK for playing, the weighted length of the segment played of movie B that the user watches is 3.6+33.3=36.9 minutes.

C and H are the starting positions for the user to watch two segments played in movie B, and they lie in the positions of 12 minutes and 102 minutes, respectively; D and K are the interruption positions of the two segments played which lie in the positions of 24 minutes and 120 minutes, respectively, wherein D is the position of the first interruption and K is the position of the second interruption.

The length of the above-mentioned segment played and the corresponding time weight could be determined by the corresponding starting position and the interruption position for watching, and the 0 minute position of the program could also be the starting position for watching and the 120 minutes position which is the terminal of the program could be the interruption position.

After obtaining the weighted lengths of the segments played, the sum of the weighted lengths of the segments played could be used to acquire the user's interest degree in movie B.

Of course, as long as the time weights of at least two segments are different, the curve of the variation of the time weight with the pre-set time for playing a program could be of various other shapes, and the corresponding weighted length of segment played could be obtained from the area formed by the region enclosed within the time weight curve to which a segment played corresponds and the X-axis. However, the sum of the areas formed by the region enclosed within the time weight curve to which each segment of a program corresponds and the X-axis equals to the pre-set total time length for playing the program.

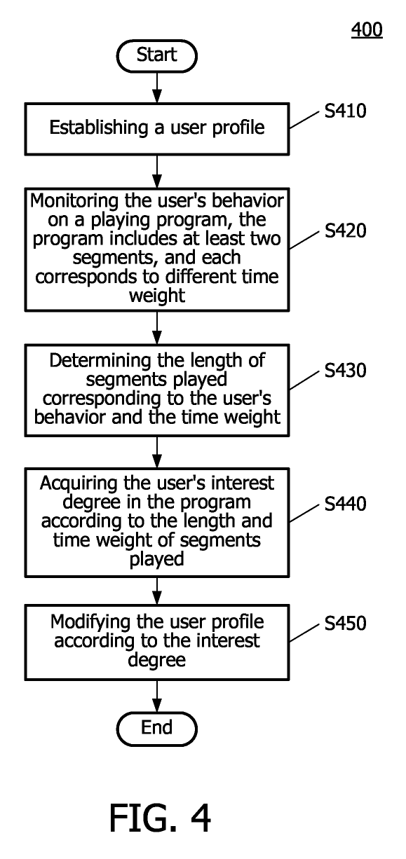

FIG. 4 is a flow chart of estimating the user's interest degree in a playing program and modifying the user profile according to one embodiment of the present invention.

First, a user profile is set up (step S410). The user profile includes the user's like-degree for at least one content feature and the weight. Of course, if the user profile has already been available, the step could be omitted.

The content features refers to the actors names (e.g., Fan Bingbing, Ge You) included in the program, the types of program (literary movie, romance movie and horror movie, etc.), the director (e.g., Zhang Yimou, Feng Xiaogang, etc.), and so on in the program. These content features could be from information sources such as the broadcast, television or the Internet, etc, among which the most representative one is that they are transmitted to the user together with the program by the digital television electronic program guide (EPG).

The content feature in the user profile may be only one, e.g., only some actor. Of course, there could also be a plurality of content features in the user profile, then the corresponding recommendation result would be more accurate.

The like-degree refers to the user's feeling to each content feature, which could be a range of value pre-set by the user or by the provider, such as [−50, +50].

The weight refers to the influence of the different types of content features, e.g., the actor, direction, program type, etc., on the selection result when the user is selecting program; or it could usually be the standard by which the user selects the program that he likes, i.e., selecting the program that he likes by the actor, or the type of program or the direction, etc. Wherein the weights of all actors could be the same, and the same is true with the weights of all the types of program and all the directors. The weight could also be a value of range pre-set by the provider, such as [0, 100].

The above-mentioned user profile could be filled in by the user himself and be initialized, but this is not the only way, because the user profile could be obtained through other methods, for instance, the manufacturer initializes the user profile with respect to the recommendation system according to the basic information of the user (such as sex, age).

A series of content features are included in the above-mentioned user profile, each of them has a ternary array (Content feature term, Like-Degree, Weight). Thus the user profile (UP) could be represented as a vector (t, ld, w) of the ternary array, so if the user profile has m different content feature terms, it could be represented by the following vector array:
UP=((t₁,ld₁,w₁),(t₂,ld₂,w₂), . . . (tᵢ,ldᵢ,wᵢ) . . . , (tₘ,ldₘ,wₘ)) (1)

in which tᵢ is a content feature, i is the sequential numeral of content feature tᵢ, ldᵢ is the like-degree for content feature tᵢ, wᵢ is the weight of content feature tᵢ.

Suppose there is a user profile which is initialized as follows:

Type of program: weight=90

Movie like-degree=50

Drama like-degree=50

News like-degree=−20, wherein the negative number indicates the degree of unlikeness,

then, the ternary array of the user's interest in the content feature in the type of program is (movie, 50, 90);

Actor: weight=80

F like-degree=10

S like-degree=45

T like-degree=−12.5;

then, the ternary array of the user's interest in actor F among all the actors is (F, 10, 80).

Second, the user's behavior on a playing program is monitored, and the program includes at least two segments which correspond to different time weight, respectively (step S420).

The user's behavior includes the position at which the playing of the program is interrupted each time, the times of interruptions, the length of the segment played from the corresponding starting position for watching to the interruption position, etc. The starting position for watching could be the zero minute position of the program, and the interruption position could be the termination position of the playing of the program. The times of interruption is caused by switching to other programs, pausing and stop watching when the user is watching a specific program.

The program includes at least two segments which correspond to different time weights, respectively. In other words, there are at least two segments in the program which have different time weights. The above-mentioned segment played is the segment that the user has watched.

For example, the previously mentioned movie A includes four segments, each of them has a different time weight, wherein the time weights of segment ab for playing and segment cd for playing are 0.6 and 2, respectively.

Afterwards, the length of the segment played that corresponds to the user's behavior and the time weight are determined (step S430).

The position of the segment played is usually determined by the interruption position and the watching start position in the user's behavior, and the length of the segment played as well as the corresponding time weight are determined.

For example, the watching start positions of segment ab played and segment cd played in movie A are respectively a position which is 30 minutes and c position which is 90 minutes, and the interruption positions are respectively b position which is 60 minutes and d position which is 120 minutes, wherein b is the first interruption position and d is the second interruption position.

The time weight of segment ab played is 0.6, so the length of the segment played is 60−30=30 minutes; if the time weight of the segment played is 2, the length of the segment played is 120−90=30 minutes.

Of course, the time weight could also be determined by the times of interruption and the interruption positions through fuzzy logic reference rule.

Subsequently, the user's interest degree in the program is acquired according the length of the segment played and the time weight (step S440).

The interest degree could be acquired according to the formula of

$$\frac{( {W}_{Di} - θ )}{{R}_{Di}} * 10.$$

Therefore, the pre-set total time length for playing a program, i.e., the total length of the program R_{Di}, needs to be obtained in the first step; in the second step, the weighted length W_{Di} of the segment played is obtained, and it could be obtained through the above-mentioned length of the segment played and the corresponding time weight; in the third step, the above-mentioned two values and the pre-set threshold θ are substituted into the above formula to obtain the interest degree.

For example, the pre-set total time length for playing movie A is 120 minutes, that is, the total length of the movie A is R_{Di}=120 minutes.

Wherein the weighted lengths of segment played for segment ab played and segment cd played could be obtained by multiplying the length of the segment played and the corresponding time weight: i.e., the weighted length of segment played for segment ab played is 0.6*30=18 minutes and the weighted length of segment played for segment cd played is 2*30=60 minutes, so the sum of the weighted lengths of segments played in movie A that the user watches is W_{Di}=18+60=⁷⁸ minutes.

If the pre-set threshold 0 is 20 minutes, substituting the data of the segment ab for playing and segment cd for playing into the formula

$$\frac{( {W}_{Di} - θ )}{{R}_{Di}} * 10 ,$$

then the user's interest degree in movie A could be obtained.

$$\frac{( {W}_{Di} - θ )}{{R}_{Di}} * 10 = \frac{( 78 - 20 )}{120} * 10 = 4.83$$

Since the user usually interrupts a program constantly only because that he does not like it, so when considering the interruption information, such as the times of interruption and the positions of interruption, etc., the weighted length of the segment played could be subtracted by an appropriated value, that is, the user's interest degree in a program could be obtained according to the length of the segment played, the time weight, and the times of interruption or the positions of interruption. In this case, after further processing the weighted length of the segment played according to the times of interruption, the processed weighted length of the segment played will be used to obtain the user's interest degree in the program.

The weighted length W_{Di} of the segment played is usually subtracted by a product of the corresponding time length of the interruption and an interruption coefficient N. Provided that the interruption coefficient is 0.05, but actually, the interruption coefficient could also be pre-set by the provider and the value range thereof is generally a very small positive decimal fraction, such as [0.0001, 0.1].

The two segments played in movie A are still taken as an example, the corresponding time length of interruption is the length of segment bc, which are 30 minutes and 0 minute (since d position is the terminal of movie A), respectively, then the weighted length of the segment played is W_{Di}=78−(30*0.05)−(0*0.05)=76.5 minutes.

Accordingly, after subtracting the influence caused by the interruptions, the user's interest degree in movie A is:

$$\frac{( {W}_{Di} - θ )}{{R}_{Di}} * 10 = \frac{( 76.5 - 20 )}{120} * 10 = 4.7083$$

In addition, if the finally obtained sum of the weighted lengths of the segments played is less than the pre-set threshold θ, the interest degree will be set as zero; if the time value at the final interruption is less than the pre-set threshold θ, the interest degree will also be set as zero.

Finally, the user profile is modified according to the interest degree (step S450). Modifying the user profile mainly concerns modifying the like-degree for the content feature corresponding to the program and the value of the weight in the user profile, and it is usually performed according to the following equations:

$$\begin{matrix}{Weight}_{ti}^{′} = {Weight}_{ti} + {α}_{t} \cdot \frac{( {WD}_{i} - θ )}{{RD}_{i}} & ( 2 ) \\ {Like\_degree}_{i}^{′} = {Like\_degree}_{i} + {β}_{i} \cdot \frac{( {WD}_{i} - θ )}{{RD}_{i}} & ( 3 )\end{matrix}$$

wherein t (Term) represents the content feature, i represents a sequential numeral of the content feature, i.e., content feature i, Weightₜᵢ represents the initial weight of content feature i, Like_degreeᵢ represents the user's initial like-degree in the content feature i. Weight′ₜᵢ represents the changed weight of content feature i, Like_degree′ᵢ represents the changed user's like-degree. W_{Di} is the real time length for the user to watch the program that contains content feature i, R_{Di} is the pre-set total time length for playing the program, θ is the pre-set threshold.

αₜ and βᵢ are the weight adjustment coefficient and the like-degree adjustment coefficient, and they could be a constant value, for example, the value for αₜ could be [0.1, 1.0], and βᵢ could also be [0.1, 1.0]. The two coefficients are respectively used for adjusting the interest degree

$$\frac{( {WD}_{i} - θ )}{{RD}_{i}}$$

in the weight of the type of content feature i and user's interest degree

$$\frac{( {WD}_{i} - θ )}{{RD}_{i}}$$

in the like-degree for content feature i. αₜ and βᵢ are usually used for delaying the changes in weight and like-degree, and they could either be set by the user or by the provider. Since the weight of the user's likeness is relatively stable, so αₜ≦βᵢ, and βₜ of the same type are usually the same.

For a user profile, provided that the range of Weight is [0, 100], and the range of like-degree is [−50, 50],
if Weight′ᵢ>1, make ‘Weight’ᵢ=100
if Weight′ᵢ<0, make ‘Weight’ᵢ=0;
if Like-degree′ᵢ>0.5, make Like-degree′ᵢ=50
if Like-degree′ᵢ<−0.5, make Like-degree′ᵢ=50

For example, the weight of actor F in movie A and the like-degree for him could be obtained by the above equation. In the user profile, the user's like-degree for actor F is 10, and the weight of the user to the actor is 80, suppose αₜ is 0.1, and βᵢ is 0.5, and the interruption information such as the previously mentioned times of interruption and positions of interruption, etc. is not considered, then, the changed like-degree and weight are

$${Weight}_{ti}^{′} = {Weight}_{ti} + {α}_{t} \cdot \frac{( {WD}_{i} - θ )}{{RD}_{i}} \cdot 10 = 80 + 0.1 * 4.83 = 80.483$$

$${Like\_degree}_{i}^{′} = {Like\_degree}_{i} + {β}_{i} \cdot \frac{( {WD}_{i} - θ )}{{RD}_{i}} \cdot 10 = 10 + 0.5 * 4.83 = 12.415$$

The method and apparatus in the present embodiment for estimating the user's interest degree in the program and updating the user profile adjust the length of the segment played that corresponds to the user's behavior according to the different time weights to which at least two segments correspond respectively, so that the situation in the prior art is avoided that as long as the length of the segments played are the same, the user's like-degree for each content feature in the program are considered as the same despite of whichever segment played the user has watched, thereby the inaccuracy in estimating the user's interest degree is reduced.

Meanwhile, the present embodiment also takes into account the case of user's interruption which may be caused by the reason that the user does not like the program very much. Therefore, this embodiment takes into account the situation of many times interruptions in adjusting the length of the segment played so as to more accurately acquire the user's interest degree in the program.

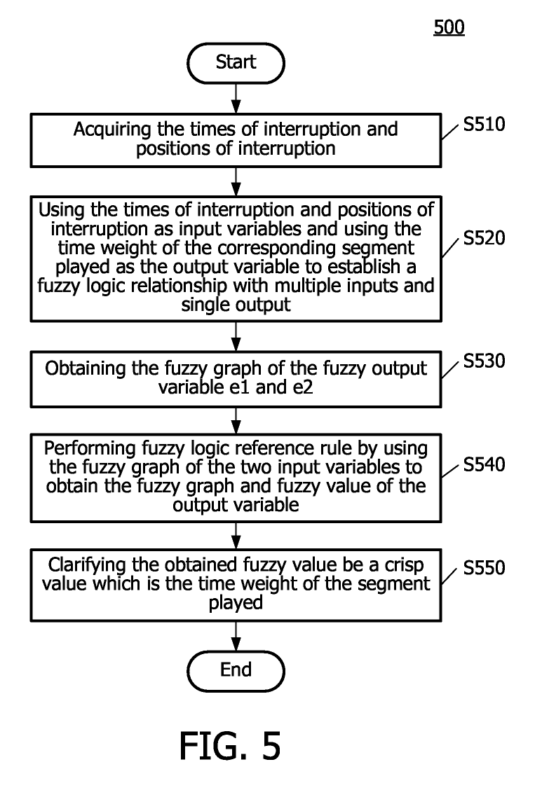

FIG. 5 is a flow chart of acquiring the time weight by means of fuzzy logic according to one embodiment of the present invention. In this embodiment, the time weight is acquired mainly with respect to the interruption information of many times interruptions in combination with the position of the segment played that the user watches as well as the influence of the times for interruptions on the user's likeness. In this embodiment, the times for interruption and positions of interruption are used as input variables, and the time weight of each segment played is obtained through fuzzy logic reference rule.

In the first step, the times for interruption and positions of interruption are acquired (step S510). Suppose the times of interruption is N−1, then the user has watched N segments; suppose the start watching position of the i-th segment played (t1, t2) is t1, and the interruption position is t2, then the corresponding times of interruption is i.

In the second step, the time i and the interruption position t2 are used as input variables and the time weight of the user to the i-th segment played is used as the output variable for establishing a variable relation of multiple inputs and single output (step S520). Provided that the times of interruption e1=i; e2=t2; and αᵢ=the time weight of the i-th segment played.

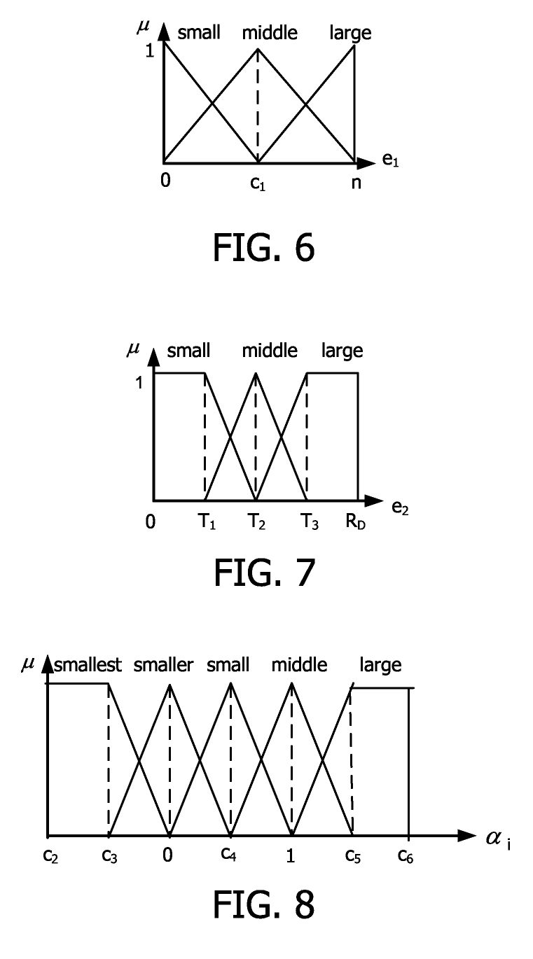

In the third step, the fuzzy graph of the fuzzy input variables e1 and e2 is obtained (step S530). This step could be realized by the available fuzzy logic reference rule. The fuzzy logic graphs thereof are as shown in FIG. 6 and FIG. 7. FIG. 6 is the fuzzy set graph of input variable e1, and FIG. 7 is the fuzzy set graph of input variable e2, wherein μ represents the grade of membership of e1 and e2.

In the fourth step, using the fuzzy graph of the two input variables to make fuzzy logic reference rule so as to obtain the fuzzy graph of the output variables and the fuzzy values thereof (step S540). That is, obtaining the output variables through fuzzy logic reference rule, i.e., the fuzzy graph of the time weight αᵢ and the fuzzy value thereof. FIG. 8 is the fuzzy graph of output variable αᵢ, wherein the grade of subordination μ of the output variable is obtained on the basis of the grade of subordination of e1 and e2 in FIGS. 6 and 7 through fuzzy logic reference rule.

The fuzzy logic reference rule is carried out under the principle that if e1 is large, αᵢ is small, and if e2 is large, αᵢ is large, so that the magnitude of the fuzzy value of the time weight αᵢ of the user to the segment played i is determined. Therefore, the specific fuzzy logic reference rule principle could be obtained as follows:

I. if e1 is “large” and e2 is “large”, then αᵢ is “small”;

II. if e1 is “large” and e2 is “middle”, then αᵢ is “smaller”;

III. if e1 is “large” and e2 is “small”, then αᵢ is “smallest”;

IV. if e1 is “middle” and e2 is “large”, then αᵢ is “middle”;

V. if e1 is “middle” and e2 is also “middle”, then αᵢ is “small”;

VI. if e1 is “middle” and e2 is “small”, then αᵢ is “smaller”;

VII. if e1 is “small” and e2 is “large”, then αᵢ is “large”;

VIII. if e1 is “small” and e2 is “middle”, then αᵢ is “middle”;

IX. if e1 is “small” and e2 is “small”, then αᵢ is “small”.

In the fifth step, clarifying the obtained fuzzy value to obtain a crisp value which is the time weight αᵢ of the segment played i (step S550).

In order to make the final result be easily understood, the result of fuzzy logic reference rule must be converted into clarified value. The most common deblurring algorithms are area gravity center method and maximum average value method. The former, which is suitable for smooth control, synthesizes the rules of all the activated outputs as the result, and it is the common method for process control.

The present embodiment adopts area gravity center deblurring algorithm, as shown in formula (4):

$${α}_{i} = {\sum }_{l = 1}^{p} μ [ l ] {y}_{l} / {\sum }_{l = 1}^{p} μ [ l ] \qquad ( 4 )$$

wherein,

μ [1] represents deducing the height of the output area from the first rule;

y1 represents deducing the X-axis of the gravity of the output area from the first rule;

p represents the satisfied number of deduced rules.

By means of the above formula, the definite value of αᵢ could be obtained, and as for the specific process thereof, reference could be made to the Chinese patent application No. 200310123354.7 (applicant: Koninklijke Philips Electronics N. V., inventor: Shi Xiaowei, filing date: Dec. 15, 2003).

Then, the weighted length of segment played for the segment played could be obtained through the obtained time weight of the segment played, so that the user's interest degree could be further acquired.

While the invention has been described in conjunction with specific embodiments, it is evident that many alternatives, modifications and variations will be apparent to those skilled in the art in light of the foregoing description. Accordingly, it is intended to embrace all such alternatives, modifications and variations as fall within the spirit and scope of the appended claims.

1. A method for estimating a user's interest degree in a playing program, comprising the steps of:
a. monitoring the user's behavior on the program including at least two segments each of which correspond to different time weight;
b. determining the length and the time weight of the segment played corresponding to the behavior; and
c. acquiring the user's interest degree in the program according to the length and the time weight of segment played.

2. A method as claimed in claim 1, wherein the time weight is set by the user.

3. A method as claimed in claim 1, wherein the time weight is set by the program provider.

4. A method as claimed in claim 1, wherein the user's behavior includes the position of interruption at which the user interrupts playing the program each time, wherein step (b) includes:
determining the position of the segment played according to the position of interruption; and
obtaining the length of the segment played and the time weight according to the position of the segment played.

5. A method as claimed in claim 1, wherein the user's behavior includes the times of the user's interruption in playing the program, wherein step (c) includes acquiring the user's interest degree in the program according to the length and the time weight of the segment played as well as the times of interruption in playing.

6. A method as claimed in claim 1, wherein step (c) includes:
(i) obtaining the total length of the program;
(ii) processing the length of the segment played and the time weight to obtain a weighted length of segment played;
(iii) comparing the total length with the weighted length of segment played to acquire the user's interest degree in the program.

7. A method as claimed in claim 1, wherein the user's behavior includes the times of the user's interruption in playing the program and the positions of interruption, wherein step (b) includes using the times of interruption and the positions of interruption corresponding to the segment played as input variables to obtain the time weight corresponding to the segment played through the method of fuzzy logic reference rule.

8. A method as claimed in claim 1, wherein the time weight of at least one segment is a specific value for reducing the interest degree.

9. A method for updating the user profile, comprising the steps of:
a. monitoring a user's behavior on a playing program including at least two segments each of which correspond to different time weight;
b. determining the length of the segment played corresponding to the behavior and the time weight;
c. acquiring the user's interest degree in the program according to the length and the time weight of segment played;
d. modifying the user profile according to the interest degree.

10. An apparatus for estimating the user's interest degree in a playing program, comprising:
an interactive means, for monitoring the user's behavior on the program including at least two segments each of which correspond to different time weight;
a determining means for determining the length and the time weight of the segment played corresponding to the user's behavior; and
an acquiring means for acquiring the user's interest degree in the program according to the length and the time weight of segment played.

11. An apparatus as claimed in claim 10, wherein the user's behavior includes the position of interruption at which the user interrupts the program each time, the determining means comprises:
a position determining means for determining the position of the segment played on the basis of a interruption position; and
a segment acquiring means for acquiring the length and the time weight of the segment played on the basis of the position of the segment played.

12. An apparatus as claimed in claim 10, wherein the user's behavior includes the times of the user's interruption in playing the program, and wherein the acquiring means is further used for acquiring the user's interest degree in the program according to the length and the time weight of the segment played as well as the times of interruption in playing.

13. An apparatus as claimed in claim 10, wherein the acquiring means further comprise:
a length acquiring means for acquiring the total length of the program;
a weighting means for processing the length of the segment played and the time weight to obtain a weighted length of segment played; and
a comparing means for comparing the total length and the weighted length of segment played to acquire the user's interest degree in the program.

14. An apparatus for updating the user profile, comprising:
an interactive means, for monitoring the user's behavior on a playing program including at least two segments each of which correspond to different time weight;
a determining means for determining the length of the segment played corresponding to the user's behavior and the time weight;
an acquiring means for acquiring the user's interest degree in the program according to the length and the time weight of segment played; and
a modifying means for modifying the user profile according to the interest degree.
